(19) United States
(12) Patent Application Publication
(10) Pub. No.: US 2018/0222099 A1
(43) Pub. Date: Aug. 9, 2018

(54) INJECTION MOLDING MACHINE WITH STACK MOLD FOR INJECTION COMPRESSION MOLDING APPLICATIONS AND INJECTION COMPRESSION MOLDING PROCESS

(71) Applicant: NETSTAL-MASCHINEN AG, Näfels (CH)

(72) Inventors: Jean-Luc GRANGE, Mogneneins (FR); Thomas ITEN, Zürich (CH)

(73) Assignee: Netstal-Maschinen AG, Näfels (CH)

(21) Appl. No.: 15/748,525

(22) PCT Filed: Jul. 28, 2016
(86) PCT No.: PCT/EP2016/067986

§ 371 Date: Jan. 29, 2018

(30) Foreign Application Priority Data
Jul. 30, 2015 (DE) 10 2015 112 508.0

(51) Int. Cl. B29C 45/32; B29C 45/17; B29C 45/20; B29C 45/12; B29C 45/56

(52) U.S. Cl. CPC B29C 45/322; B29C 45/1777; B29C 2045/5615; B29C 45/12; B29C 45/561; B29C 45/20

(57) ABSTRACT

An injection-molding machine includes a stack mold having a snorkel supplying melt to a central part of the stack mold. A biased movable part of the snorkel and a nozzle of an injection unit can be pressed against one another during the injecting process, wherein a position of the injection unit can be fixed in the longitudinal machine direction, when the stack mold is in a position for performing a compression molding stroke. A bias and a stroke executable by the movable part of the snorkel can be adjusted, so that the nozzle and the snorkel remain pressed against each other at least while the compression molding stroke is executed during the injection process. The position of the injection unit is held during an injection process while the compression molding stroke is executed

The invention is directed to an injection molding machine with a stack mold. Different embodiments of stack molds and injection molding machines with stack molds are known in the art.

A stack mold is typically composed of several mold parts, namely:

a mold part that is fixed on the fixed platen of an injection molding machine, hereinafter also referred to as fixed stack mold part;

a mold part that is fixed on of the movable platen of the injection molding machine, hereinafter also referred to as movable stack mold part;

one or several central parts, which are disposed between the fixed and the mobile stack mold part.

Depending on number of the central parts, stack molds with two or more stacks are obtained. In the closed state of the stack mold, one or several mold cavities are formed on each stack, in which melt is introduced and solidifies to form a molded part. To distribute of the melt in the mold cavities, the center platens are provided with suitable melt distribution channels. Various measures are known in the art for supplying melt from the injection unit of the injection molding machine into the central plate(s).

It is known from U.S. Pat. No. 4,207,051 to provide above of the fixed platen two telescopically collapsible pipe pieces and to connect these pieces at of the top side of the center plate of the stack mold to a melt distribution system in the center plate.

It is known from WO 2014/153676 A1 to feed the melt to the melt distribution system in the center plate via a feed line located on the central injection axis. The feed line includes at least two mutually displaceable telescopic pipe pieces. There is no need for valves for closing the feed lines when the stack mold is opened.

An injection molding machine with a stack mold is known from JP-Y-62-18418, wherein, the injection unit can be moved relative to the stationary stack tool by way of a piston-cylinder unit. The JP-Y-62-18418 is cited in the EP0576837B1 as state of the art and is described therein as follows. The injection unit is connected with the central part by way of an elongated injection cylinder, which extends through a through-opening of the stationary stack mold part, wherein in the central part a mouthpiece of the injection cylinder is pressed against a port opening of central part. The contact pressure of the mouthpiece can be preset by means of the piston-cylinder unit. When the stack mold is now closed, it can be attained by suitable control of the piston-cylinder unit that the injection unit follows the likewise moving central part and the mouthpiece of the injection cylinder remains in contact at the port opening of the central part. In this way, the injection unit forms with the central part of the stack mold a unit, which does not become separated even during the opening and closing movement of the stack mold.

It is suggested in EP0576837B1 to directly connect the injection unit with the central part. In particular, a direct mechanical connection between the injection unit and the central part of the stack mold is proposed. In one embodiment, the central part of the stack mold has on its side facing the fixed platen a protruding tubular connection fitting, which is usually referred to as snorkel. The fixed platen and the fixed stack mold part each have a center opening, into which the snorkel can protrude in certain situations so far, that the port opening protrudes from the back side of the fixed platen when the stack mold is closed. The injection unit can be axially displaced with hydraulic actuating cylinders in order to press the mouthpiece of the injection cylinder against a port opening of the snorkel to thereby establish a connection between the injection cylinder and the central part of the stack mold which is sealed to the outside. The piston rods of the hydraulic actuating cylinders pass through openings in the fixed platen and are anchored on the central part of the stack mold. By pressurizing the chamber in front the piston of the actuating cylinder, the injection cylinder is pressed against the snorkel, and the central part of the stack mold and the injection unit form a rigidly coupled unit, so that the injection unit follows the opening and closing movement of the central part. With this entrainment of the injection unit on the central part, the coupling of the mouthpiece to the port opening of the snorkel remains unchanged during the entire injection molding process and over many injection cycles, including the mold closing and mold opening movements. The central part and the injection unit may also be connected by way of screws instead of with the hydraulic actuating cylinders.

When an increased output capacity of parts is desired, it may become necessary to perform so-called injection compression molding with one stack mold. Various embodiments of injection compression molding are known in the art, obviating the need for a detailed discussion here. It is important with injection compression molding with stack molds that the mouthpiece or the nozzle of the injection unit is pressed against the snorkel so as to be able to inject, although the snorkel is displaced during the compression molding movement in the direction of the injection unit. The contact force on the snorkel during the compression molding process should preferably be constant. The snorkel could sustain damage under a heavy load or the position of the central part of the stack mold could change.

The injection molding machines with a stack mold known from JP-Y-62-18418 and EP0576837B1 can also be used to perform injection compression molding processes, because the injection unit abuts the central part or a snorkel of the central part in every position of the stack mold. However, the JP-Y-62-18418 disadvantageously requires more complex control technology. In the EP0576837B1, the mold closing must move with it the entire aggregate. This requires either an increased drive power, which makes injection compression molding less interesting. Or the movement is slowed down which makes the cycle time less interesting. Lastly, rapid movement of the injection unit has certain safety risks, unless the injection unit is enclosed in an expensive housing, which in turn impedes accessibility.

Based on this state of the art, it is the object of the invention to provide a different injection molding machine with a stack mold that is suitable for injection compression molding processes.

The object is solved with an injection molding machine having the features of claim 1. Advantageous embodiments and refinements are recited in the dependent claims.

Because a position of the injection unit can be locked or held at least during the injection process, especially during an injection process before or during the execution of an injection compression molding stroke of the stack mold, as seen in the longitudinal direction of the machine, in which the nozzle of the injection unit is pressed against a biased, movable part of snorkel, wherein the bias and the stroke to be performed by the movable part is adjusted or can be adjusted so that the nozzle and the snorkel remain pressed against each other during the injection process, the injection unit needs not be moved with the center plate, as was necessary in the prior art. This saves energy. The cycle time is also not adversely affected because the closing motion occurs independently from of the motion of the aggregate. Since the aggregate does not move fast, safety is enhanced. The control complexity is manageable.

According to one embodiment, one or several mechanical stops may be provided for establishing the position of the injection unit, to which stop(s) the injection unit can be moved and against which the injection unit can be pressed. Preferably, the position of the mechanical stops should be variable or adjustable in longitudinal machine direction. An operator has then the option to adjust a suitable position for one or more stops for a certain compression molding stroke of the stack mold. A clamping half-shell or counter-threaded stops can be used as a stop. These stops can for example be placed on the piston rods of a hydraulic linear drive for moving the injection unit. It would also be feasible to arrange one or several suitable stops on the front end of the injection unit, which can be supported on the fixed platen. This could be, for example, a circular stop element which surrounds the nozzle or the injection unit. Alternatively, several stop pins may be arranged on a circle around the injection unit. Moreover, one or several stops for supporting the guide shoe(s) of the injection unit may be arranged on the machine bed.

In another embodiment, a position of the injection unit in longitudinal machine direction may be fixed or is fixed by a mechanical blockade of its linear drive. With a hydraulic linear drive, this could be realized by a hydraulic blockade of the spaces occupied by the pressure medium. With an electrical linear drive, a brake may be provided which mechanically blocks an element driven by the electric motor.

According to another embodiment, a position of the injection unit in the longitudinal machine direction may be fixed or is fixed by regulating the driving force of its linear drive. It should hereby be taken into account that a counterforce is exerted on the injection unit which is variable over one injection cycle. On the one hand, the force with which the snorkel of the stack mold is pressed against the nozzle has to be considered. This force depends on of the position of the stack mold parts. The force increases when the stack mold closes. Furthermore, the force generated during injection of the melt into the stack mold must be taken into account.

The aforementioned possibilities for establishing the position of the injection unit may if necessary also be combined.

The snorkel may be designed to have a first snorkel part connected with a central part standing and a second snorkel part which is movable relative to the first snorkel part and faces the nozzle of the injection unit. These two snorkel parts are telescopically movable relative to one another, so that a continuous melt channel is formed that runs through both snorkel parts. Melt from the injection unit can be fed through this melt channel to the central part(s). The second snorkel part is preferably biased with respect to the first snorkel part in the direction of the nozzle and displaceable with respect to the first snorkel part by a snorkel stroke, wherein the snorkel stroke should be designed commensurate with a defined compression molding stroke of the stack mold. This snorkel stroke should be sized to correspond at least to the compression molding stroke of the stack mold. The compression molding stroke of the stack mold typically conforms to the molded part to be produced and may hence vary from one molded part to the next. However, different compression molding strokes may also be executed for the same molded part in dependence of the defined injection molding process.

A nozzle sealing mechanism, which seals on the plasticizing side, may be arranged on the front end of the plasticizing cylinder. For thinner plastic melts, a so-called valve gate is used as nozzle seal mechanism. When the valve gate is open, the melt can freely flow from there until reaching the mold. Nozzle needles may be arranged in the mold which block or open the path for the melt into the cavities. No additional closure element is required between these two closures. Moreover, the nozzle is rarely lifted from the snorkel in normal operation. However, if this occurs, leakage from the snorkel and to a lesser degree also from the nozzle may occur. If, however, these two parts are to be separated, the screw can preferably be retracted before the separation, i.e. the screw is withdrawn by a certain stroke in order to decompress the melt in the hot runner and in the nozzle tip. This can reduce leakage.

Furthermore, attention should preferably be paid to the design of the components of the injection molding machine carrying the melt, hereinafter also referred to as melt channels, so as to minimize shear energy which would damage the plastic. Moreover, suitable heating of the melt channels must be provided in order to maintain a suitable viscosity of the plastic. After the melt transitions from plasticizing into a stack mold, the melt still travels a significant distance in the snorkel, which forms the connection between plasticizing and the center plate of the mold. The center plate has additional melt channels, which are also referred to as hot runners or as hot runner manifold. Nozzles are also arranged at the transition from the hot runners to the cavities in the stack molds. Preferably, the melt channel in the snorkel is generously designed for optimum rheology. Moreover, stack molds are especially employed in conjunction with low viscosity plastics which exhibit little shear heating during passage through the melt channels. To regulate the temperature around the ideal process temperature, the snorkel can be heated along its entire length or along sections. The snorkel can therefore also be designated as a hot runner. In the center plate of a stack mold, the melt stream is divided among distribution channels into individual streams and transported to the mold nozzles located proximate to the cavities. Such distribution channels are frequently also referred to as hot run manifolds. The nozzle in front of the cavity is also heated to prevent solidification of the plastic melt awaiting injection into the nozzle antechamber.

Heating occurs preferably by way of resistance heaters disposed in suitable areas of the melt channels. Heating tapes may be used for the externally accessible areas. This applies especially to the plasticizing cylinder, the nozzle at of the plasticizing unit and the snorkel. Optionally, so-called thick film heaters may also be provided.

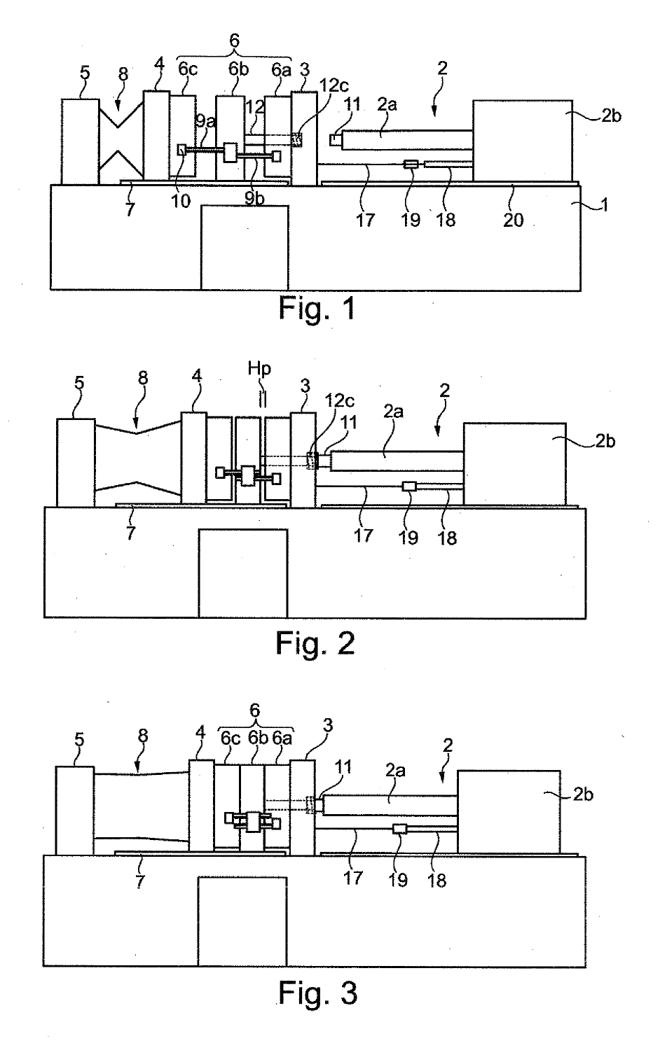

The invention will now be described in more detail based on embodiments and with reference to the FIGS. 1 to 7, which show in:

FIG. 1 an embodiment with a mechanical stop when the stack mold is open;

FIG. 2 as FIG. 1, however with the stack mold in a position for the compression molding stroke H_{P};

FIG. 3 as FIG. 1, however after execution of the compression molding stroke H_{P};

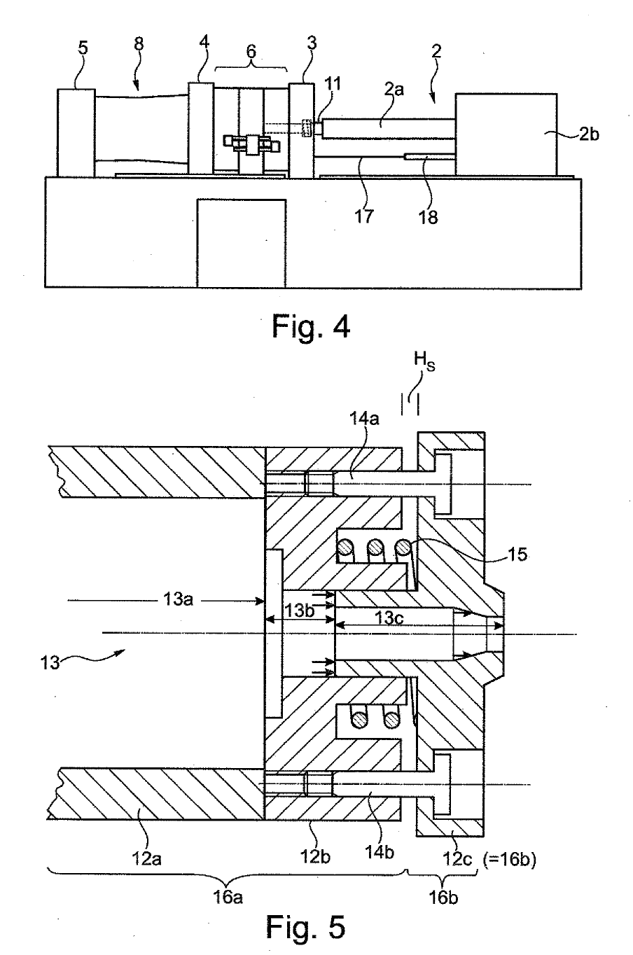

FIG. 4 an embodiment without a mechanical stop in a closed position of the stack mold;

FIG. 5 an embodiment of a snorkel with a biased element;

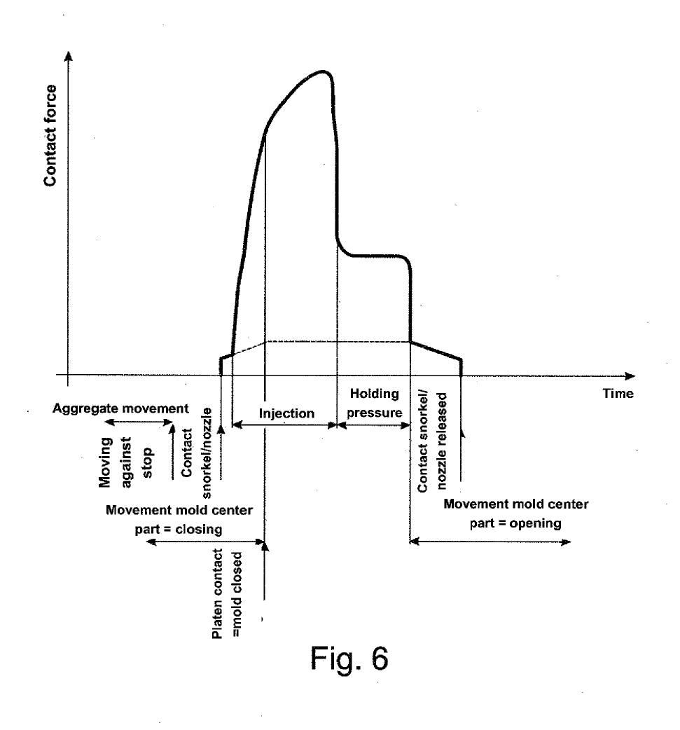

FIG. 6 path of the contact force between of the nozzle of the plasticizing and the biased, movable element of the snorkel for the duration of an injection molding cycle; and

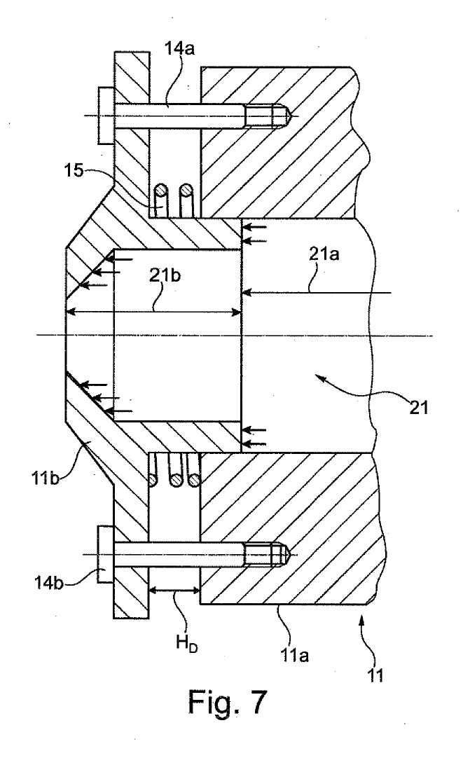

FIG. 7 an embodiment of a nozzle with a biased element.

A first embodiment of an injection molding machine according to the invention and its operation during injection compression molding will be described hereinafter in more detail with reference to the FIGS. 1 to 3. Such injection molding machine for injection compression molding with a stack mold includes on machine bed 1, on which an injection unit 2, a fixed platen 3, a movable platen 4 and a support platen 5 are arranged. The injection unit designated overall with of the reference numeral 2 includes essentially a cylinder 2a with an enclosed rotatably and linearly driven screw for plasticizing and expulsion of melt, a drive unit 2b with a linear drive for displacing the screw in the longitudinal machine direction, and a rotary drive for rotationally driving the screw. A nozzle 11 is disposed at the front end of the cylinder 2a, by way of which the melt is expelled from the cylinder 2a in a forward movement of the screw and injected into an injection mold. In the present case, the injection mold is constructed as a stack mold 6 and includes three mold parts, from which two stacks can be formed. The nozzle-side mold part 6a of the stack mold 6 is attached to the fixed platen 3, whereas the closure-side mold part 6c is arranged on the movable platen 4. The central part 6b of the stack mold 6 is supported by guide rails 7 arranged on at the machine bed 1. However, the central part 6b may also be supported and guided on columns (not shown here). The central part may also be suspended on columns. A toggle mechanism 8 that may be operated by suitable drives (only schematically illustrated in FIG. 1) may be provided to move the movable platen 4. Injection molding machines with a toggle mechanism are known, so that further details of the toggle mechanism and its drive need not be described here in detail. The central part 6b is driven by way of a mechanical connection to at least the closure-side mold part 6a. Especially common is entrainment of the central part 6b by articulated levers or toothed racks. In the illustrated example, the central part 6b is entrained by means of toothed racks 9a and 9b which are in engagement with a gear 10 disposed on the central part 6b.

The central part 6b and the movable stack mold part 6c move in direction of the support plate 5 when the mold opens. An unillustrated sprue and distribution system is integrated in the central part 6b, via which the melt can be distributed in the work planes or stacks of the stack mold, in order to supply melt to the mold cavities formed in the stacks. This necessitates a tubular extension toward to the nozzle 11 on the cylinder 2a of injection unit 2, a so-called snorkel 12, through which the melt can be directed to the central part 6b. The snorkel 12 moves in conjunction with the central part 6b when the stack mold 6 opens and closes, which may cause the snorkel 12 to lift off the nozzle 11. The snorkel 12 protrudes at least into the recess of the fixed platen 3. When the stack mold 6 is closed, the snorkel 12 may even protrude past the fixed platen 3.

In the illustrated embodiment, the snorkel 12 is provided toward the nozzle 11 with a biased, movable element. The construction of such snorkel 12 is shown in more detail in FIG. 5. Because of the enlarged scale, only the end of the snorkel 12 facing the nozzle 11 of the injection unit 2 is shown. A flange 12b which is connected to the central part 16b and contains a melt channel 13a is also connected to the snorkel body 12a. A fitting 12c for the nozzle 11 is, on the one hand, movably guided in the flange 12b and on two screws 14a, 14b connected with the flange 12b; on the other hand, the screws 14a, 14b also serve as precaution against loss. Flange 12b and fitting 12c are biased against each other, either by a spring, for example a circular spring 15 or by several individual springs arranged on a bolt circle. This creates a first snorkel part 16a connected to a central part 6b, which in the present example is formed by the snorkel body 12a and the flange 12b, and a second snorkel part 16b which is movable relative to the first snorkel part 16a and faces the nozzle 11 of the injection unit 2 which in the present example is formed by the fitting 12c. The two snorkel parts 16a and 16b can move telescopically relative to one another, thereby creating a continuous melt channel 13 with sections 13a, 13b and 13c and extending through both snorkel parts 16a, 16b.

The second snorkel part 16b is biased with respect to the first snorkel part 16a in direction of the nozzle 11 and is movable with respect to the first snorkel part 16a by a snorkel stroke Hₛ, wherein the snorkel stroke Hₛ is designed commensurate with a certain compression molding stroke H_{P} of the stack mold 6 and sized so as to correspond to at least this compression molding stroke of the stack mold 6, i.e. Hₛ≥H_{P}. The biased, displaceable element may conceivably also be constructed differently, i.e. FIG. 5 should only be taken as an example. For example, the snorkel body 12a and the flange 12b may also consist of a single piece having an end region, which is suitably designed to cooperate with a matching fitting 12c.

The biased, displaceable element can also be integrated in the nozzle. The construction of such a nozzle equipped with a biased, displaceable element appointed is shown in more detail in FIG. 7. Only a section around the top of the nozzle 11 is shown. The second nozzle part 11b is connected to the first nozzle part 11a that contains a melt channel 21a. The second nozzle part 11b is attached to the snorkel 12 and has a melt channel 21b. The second nozzle part 11b is movably guided in the first nozzle part 11a and on two screws 14a, 14b which are connected to the first nozzle part 11a. The screws 14a, 14b serve at the same time as protection against loss. The two nozzle parts 11a and 11b are biased against each other, either by a spring, for example a circular spring 15 or by several individual springs arranged on a bolt circle. The two nozzle parts 11a and 11b are telescopically movable with respect to one another by a stroke H_{D}, so that a continuous melt channel 21 can be maintained with any movement. The nozzle stroke H_{D} follows and corresponds to at least the compression molding stroke H_{P} of the stack mold 6, i.e. H_{D}≥H_{P}. Advantageously, the nozzle 11 extends conically to the snorkel, as shown in FIG. 7. This produces a force in direction of the snorkel and amplifies the contact pressure.

FIG. 7 shows only an example of an embodiment of the biased movable nozzle; however, other embodiments, for example a combination of the nozzle with the cylinder head via a biased element between nozzle and cylinder head are conceivable. The biased element may be disposed in the nozzle and biased in the direction of the cylinder head. Alternatively, the biased element may be disposed in the cylinder head and biased in the direction of the nozzle. The cylinder head is to be understood here as the front end of cylinder 2a facing the nozzle 11.

In injection molding without injection compression molding, the injection unit 2 presses via the nozzle 11 of the plasticizing 2a against the snorkel 12 of the stack mold 6. When injecting with comparatively high pressures, for example with pressures greater than 1500 bar and in particular with pressures greater than 2000 bar, the nozzle 11 and thus the injection unit 2 could lift off the snorkel 12, unless they are pressed against the snorkel 12, because the melt stream in the mold experiences a resistance. Moreover, in an injection compression molding process, as in the present example, the nozzle 11 or the injection unit 2 are not allowed to lift off the snorkel 12 during injection. It should be noted with injection compression molding that the stack mold 6 is not completely closed at the start of the injection, but has instead an opening of the size of the so-called compression molding stroke. To completely fill the mold, a smaller mold stroke, the so-called compression molding stroke H_{P}, is executed which affect a stroke of the snorkel 12. This stroke of the snorkel 12 can be compensated directly at the snorkel 12 by an element, for example the aforedescribed biased movable element, namely the snorkel part 16b. As soon as the injection starts, a force between the nozzle 11 and the snorkel 12 must be built up to prevent a leakage.

In the embodiment of FIG. 1, a hydraulic linear drive is provided for moving the injection unit 2 and for pressing of the nozzle 11 against the snorkel 12. The hydraulic linear drive includes a pressure cylinder 18 and a piston rod 17 connected to the fixed platen 3. Usually, two hydraulic linear drives are provided which are arranged symmetric to central longitudinal machine axis. A mechanical stop 19 is arranged on the piston rod 17 of the pressure cylinder 18 which is connected to the drive unit 2b. This stop may be formed of clamping half-shells, or countered (locked) threaded stops may be used. Usually, two pressure cylinders 18 are provided on both sides of the longitudinal machine axis. In this case, a mechanical stop 19 may be disposed on one of the piston rods. Alternatively, a respective stop may also be disposed on each of the two piston rods.

In the illustrated example, the mechanical stop is affixed to the piston rods 17 of the pressure cylinder 18. However, the mechanical stop may also be placed at other locations of the machine. For example, a rim which is supported on of the fixed platen 3 may be placed on the head of the cylinder 2a. It is also conceivable to provide one or several other suitable stops at the front end of the injection unit, which may be supported on the fixed platen. For example, several stop pins could be provided which are arranged on a circle around the injection unit 2 and are supported on the fixed platen 3. Alternatively, stops could be attached on the guide rail(s) 20 of the injection unit 2, against which the unillustrated guide shoe(s) of the injection unit 2 bump.

The mechanical stop(s) 19 should be designed so that their position can be adjusted by the machine operator. This enables an operator to adjust a suitable position of the stop(s), for a certain compression molding stroke H_{P} of the stack mold in order to fix the injection unit 2 at this position.

At the start of a cycle or at start of the production, the injection unit 2 approaches the mechanical stop 19 with a certain force and presses against the stop 19. Subsequently or at the same time, the stack mold 6 closes down to the injection compression molding gap or the compression molding stroke H_{P}. Shortly before the mold parts 6a, 6b and 6c of the stack mold 6 reach the position for the compression molding stroke H_{P} during closing, the snorkel 12 and the nozzle 11 make contact. During further closure to the injection compression molding gap or the compression molding stroke H_{P}, the spring 15 in the biased movable element (fitting 12c) is slightly compressed and the fitting 12c pressed against the nozzle 11 with a small force. This state is shown in FIG. 2. The contact force is mainly absorbed by the mechanical stop 19, whereas smaller forces are effective at this time at the interface between the nozzle 11 and the snorkel 12. At the moment, when injection into the stack mold 6 takes place, a force in the direction of the arrow acts on the fitting 12c by way of the shoulder surface (see FIG. 5). This force exceeds the force, with which the nozzle 11 and the fitting 12c are pressed apart; this force also counteracts the closure of the stack mold 6. When the stack mold 6 closes further during the actual compression molding process, i.e. when the injection compression molding strokes H_{P} is executed, the snorkel 12 is pressed even more firmly against the nozzle 11. The biased movable element 12c is thereby moved in the direction of the flange 12b and the spring 15 is further compressed. This situation is illustrated in FIG. 3.

When injection is completed, the injection unit 2 with its nozzle 11 can again be lifted from the snorkel 12 and retracted rearward from the stop 19. Alternatively, the injection unit 2 may be held permanently pressed against the mechanical stop 19. The biased movable element, such as the fitting 12c, is cyclically relieved by the mold opening stroke when the aggregate is continuously fully pressed against the stop 19. Moreover, the mechanical stop 19 is subjected to the full force by the injection unit 2 only when the snorkel 12 is lifted from of the nozzle 11. During the mold movements (closing and opening) outside of actual embossing and injection process, i.e. when the snorkel 12 is detached from of the nozzle 11, the pressure can be relieved in the pressure cylinder 18, to reduce the risk of leakage of the pressure cylinder 18. It would be advantageous to make relieving the pressure in the pressure cylinder 18 contingent on whether the snorkel 12 and the nozzle 11 make contact. In the absence of contact, the pressure cylinder 18 can be depressurized.

FIG. 4 shows an alternative to the first embodiment shown in FIGS. 1 to 3. Instead of a mechanical stop, a certain position can also be held by a control of or by a brake in the linear drive of the injection unit. The injection compression molding cycle resembles here the injection compression molding cycle described above in the context with FIGS. 1 to 3. The injection unit 2 moves to a certain position without bumping against a stop. This position results from the compression molding stroke H_{P} of the stack mold 6 and the compression of the biased movable element 12c at the snorkel 12. In the selected position the nozzle 11 hits the biased movable element (fitting 12c) on the snorkel 12. While the stack mold 6 executes the compression molding stroke H_{P}, the injection unit 2 is held at of the previously attained position. The biased movable element 12c on the snorkel 12 is compressed by the mold stroke H_{P}. At the end of the production cycle the injection unit 2 can leave the previously attained position and move toward the rearward end position. Alternatively, the injection unit 2 may remain stationary and be arrested at the desired position for several cycles. The nozzle 11 is lifted from the snorkel 12 also when the injection unit 2 stops at its position, because the snorkel 12 follows the mold opening stroke.

The injection unit 2 may be held at the predetermined, desired position in various ways. Both with an electrical and a hydraulic linear drive the position can be held by controlling a force. For example, an electrical spindle drive may be employed as a linear drive for moving the injection unit 2. In this case, the inverter can control the servomotor of the spindle drive so as to control the position of the injection unit 2 and to hold it at the predetermined, desired position. Alternatively or additionally, a brake may also be provided in the electrical or hydraulic linear drive. It is also possible with a hydraulic linear drive to hold the pressure cylinder in position by hydraulically blocking the spaces for the pressure medium.

FIG. 6 illustrates the contact force between of the nozzle 11 and the biased movable element or fitting 12c for the duration of one injection molding cycle. The bias of the spring 15 causes a force different from zero upon contact between snorkel 12 and nozzle 11. The mold closing movement (closure of the stack mold), which for sake of simplicity is assumed to be linear, causes the force to increase further. As soon as the injection begins, the force increases rapidly. The mold continues to close in parallel, especially to execute the injection compression molding strokes H_{P}. At the end of the mold closing process, the slope of the force curve decreases by the fraction generated by the mold movement. By applying the holding pressure, the contact force decreases again. In analogy to closure or closing of the mold, a linear movement of the mold is also assumed at the opening of the mold. When the snorkel 12 lifts off the nozzle 11, the contact force between the snorkel 12 and the nozzle 11 is again zero.

Not shown in the figures are facilities for heating the components of the injection molding machine carrying the melt, in the following also referred to as hot runners. Heating is preferably performed with resistance heaters disposed in suitable areas of the hot runners. Heating tapes may be employed for the externally accessible areas. This applies especially for the plasticizing cylinder, the nozzle and the snorkel. In the present exemplary embodiment, the snorkel 12 is preferably heated in the area 12a and 12b, because the simple geometries allow a heating tape to be placed around the cylindrical parts. The area 12c need not be additionally heated, because of its small width. Alternatively, only the area 12a may be heated, whereas areas 12b and 12c may not be heated, and whereas area 12b may possibly be insulated, depending on the required accessibility of the components. The approach for the nozzle is comparable to the snorkel. Here, the area 11 is preferably heated, whereas the area 11b is not heated. Preferably, the area of the nozzle 11 farther back, which is not visible in FIG. 7, is also heated.

List of Reference Signs

| | |
|---|---|
| 1 | machine bed |
| 2 | injection unit |
| 2a | cylinder |
| 2 B | drive unit |
| 3 | fixed platen |
| 4 | movable platen |
| 5 | support plate |
| 6 | stack mold |
| 6a | fixed stack mold part |
| 6b | central stack mold part |
| 6c | movable stack mold part |
| 7 | guide rails |
| 8 | toggle mechanism |
| 9a, 9b | toothed racks |
| 10 | gear |
| 11 | nozzle |
| 11a | first nozzle part |
| 11b | second nozzle part |
| 12 | snorkel |
| 12a | snorkel body |
| 12b | flange |
| 12c | fitting |
| 13 | hot runner in the snorkel |
| 13a, b, c | sections of the hot runner 13 in the snorkel |
| 14a, 14b | screws |
| 15 | spring |
| 16a | first snorkel part |
| 16b | second snorkel part (corresponds to 12c) |
| 17 | piston rod |
| 18 | pressure cylinder |
| 19 | stop |
| 20 | injection unit guide rails |
| 21 | hot runner in the nozzle or nozzle hot runner |
| 21a, b | sections of the hot runner 22 in the nozzle |
| Hₛ | snorkel stroke |
| H_{D} | nozzle stroke |
| H_{P} | compression molding stroke |

What is claimed is:

1.-9. (canceled)

10. An injection molding machine, comprising:
an injection unit movable in a longitudinal machine direction;
a nozzle disposed at a front end of the injection unit;
a stack mold comprising a fixed stack mold part, a movable stack mold part, a central stack mold part arranged between the fixed stack mold part and the movable stack mold part, the central stack mold part and the movable stack mold part being movable relative to the fixed stack mold part and relative to each other for opening and closing the stack mold, and a snorkel constructed to supply melt from the injection unit to the central stack mold part, the snorkel and the nozzle being constructed to be pressed against each other,
wherein the injection unit is adapted to be fixed at a position, as viewed in the longitudinal machine direction, in which the nozzle is pressed against a biased movable part of snorkel, when the stack mold is in a position for executing a compression molding stroke,
wherein the bias of the movable part of the snorkel and a stroke executable by the movable part of the snorkel are adjusted such that the nozzle and the snorkel remain pressed against each other at least while the compression molding stroke is executed during an injection process, and
wherein the injection unit is held at the position during an injection process while the compression molding stroke is executed in the stack mold.

11. The injection molding machine of claim 10, further comprising a mechanical stop against which the injection unit is moveable and pressable.

12. The injection molding machine of claim 11, wherein a position of the mechanical stop in the longitudinal machine direction is variable or adjustable.

13. The injection molding machine of claim 10, further comprising a linear drive coupled to the injection unit for moving the injection unit, said linear drive being lockable by a mechanical blockade for fixing a position of the injection unit in the longitudinal machine direction.

14. The injection molding machine of claim 10, further comprising a linear drive coupled to the injection unit for moving the injection unit, and a controller for regulating a driving force of the linear drive for fixing a position of the injection unit in the longitudinal machine direction.

15. The injection molding machine of claim 10, wherein the snorkel comprises a first snorkel part connected to the central stack mold part and a second snorkel part movable relative to the first snorkel part and facing the nozzle of the injection unit, said first and second snorkel parts being movable relative to one another in a telescopic fashion so as to create a continuous melt channel running through the first and second snorkel parts, said second snorkel part being biased against the first snorkel part in a direction of the nozzle and displaceable against the first snorkel part by a snorkel stroke which is configured commensurate with a defined compression molding stroke of the stack mold and dimensioned to correspond to the compression molding stroke of the stack mold.

16. A method of operating an injection molding machine having an injection unit and a stack mold which receives melt from the injection unit for producing a molded part, comprising:
holding the injection unit in a longitudinal machine direction at a starting position, in which a nozzle of the injection unit is pressed against a biased movable part of a snorkel as the stack mold moves from an open position toward a closed position until establishing a contact between the snorkel and the nozzle and thereby approaches a position for executing a compression molding stroke;
continuing to move the stack mold until the position for executing the compression molding stroke is reached;
injecting melt from the injection unit through the snorkel into mold cavities of the stack mold;
during or after injecting the melt into the mold cavities, continuing to move stack mold to thereby execute the compression molding stroke and distribute the melt into the mold cavities of the stack mold as the mold cavities decrease in size;
applying a holding pressure to maintain the nozzle and the snorkel pressed against each other during injecting the melt into the mold cavities and while the holding pressure is applied, and
opening the stack mold and disengaging the snorkel from the nozzle.

17. The method of claim 16, further comprising:
moving the injection unit, after disengaging the snorkel from the nozzle, between cycles into a rear position;
moving the injection unit forward again to the starting position; and
holding the injection unit at the starting position.

18. The method of claim 16, further comprising holding the injection unit at a forward injection position for several cycles.
